(19) United States
(12) Patent Application Publication
(10) Pub. No.: US 2020/0217451 A1
(43) Pub. Date: Jul. 9, 2020

(54) ADJUSTABLE STAND

(71) Applicant: Thinh Pham, Greenwood, IN (US)

(72) Inventor: Thinh Pham, Greenwood, IN (US)

(21) Appl. No.: 16/736,789

(22) Filed: Jan. 7, 2020

Related U.S. Application Data
(60) Provisional application No. 62/789,487, filed on Jan. 7, 2019.

(51) Int. Cl. F16M 13/02; F16M 11/04

(52) U.S. Cl. CPC F16M 13/022; A47B 23/043; F16M 2200/08; F16M 11/04

(57) ABSTRACT

Adjustable stand. An adjustable stand for holding an object may include a base having a front lip having an inside face and a holding site for an object adjacent the inside face, as well as an adjustment mechanism configured to be positioned relative to the base, the adjustment mechanism capable of residing at multiple positions upon the base, each position of the multiple positions configured to hold the object at a different angle relative to the base.

### PRIORITY

The present patent application is related to, and claims the priority benefit of, U.S. Provisional Patent Application Ser. No. 62/789,487, filed on Jan. 7, 2018, the contents of which are hereby incorporated by reference in their entirety into this disclosure.

### BACKGROUND

The screen on an electric device can display useful information to its users. As screens get larger, the amount of information displayed at once increases as well. The screen on time necessarily must increase also to allow longer usage time so battery size also increases. As a result, the overall size and weight of the electronic device will increase too. At some point the device becomes bulky, oversized and/or too heavy to hold comfortably or for long periods of time. Furthermore, the information displayed can't be fully taken advantage of if the user must use his or her hands to manipulate the device at the same time. For example, a recipe displayed on a screen is difficult to follow if one or more hands are busy holding the screen. Thus there is a need for a device that can securely position the screen of the electronic device for the user. Furthermore, as each user is different, and lighting conditions may differ, the angle of the electronic device should be adjustable to account for these differences and maximize the visibility of the screen on the electronic device.

### BRIEF SUMMARY

In an exemplary embodiment of a device of the present disclosure, the device comprises an adjustable stand comprising a base, an adjustment mechanism and a securing mechanism. In an exemplary embodiment of an adjustable stand of the present disclosure, the adjustment mechanism and the securing mechanism are coupled with the base. Alternatively, the securing mechanism may be coupled with the adjustment mechanism either in addition to being coupled with the base or instead of being coupled with the base. In a further embodiment, the adjustment mechanism is positioned between the base and the securing mechanism. In this embodiment, the securing mechanism extends beyond the adjustment mechanism to couple with the base.

In an exemplary embodiment of an adjustable stand, the base is configured to accept an object such as an electronic device having a screen; the adjustment mechanism comprises at least two positions wherein each position holds the object at a different angle relative to the base; and the securing mechanism is operable to fix the adjustment mechanism at any of the at least two positions.

In an exemplary embodiment of an adjustable stand, the adjustable stand comprises a base wherein the base comprises a front lip, a holding site behind the front lip, and a receiving feature; an adjustment mechanism movably positioned on the base; and a securing mechanism coupled to the base at the receiving feature and operable to prevent movement of the adjustment mechanism. In a further embodiment, the device may also include a rear portion wherein the holding site is positioned between the front lip and the rear portion. In a further embodiment, the receiving feature is in the rear portion of the base.

In a exemplary embodiment of an adjustable stand, the device comprises a base wherein the base comprises an holding site and a hole; an adjustment mechanism comprising a slider movably positioned on the base and having a aperture extending along at least part of its length; and a securing mechanism comprising a rod and a handle, wherein the rod extends through the central aperture into the hole; and the handle may be manipulated to fix the adjustment mechanism and prevent it's movement.

In an exemplary embodiment of an adjustable stand, the adjustable stand comprises a base wherein the base comprises a front lip, a rear portion, and a holding site therebetween; an adjustment mechanism comprising a slider movably positioned on the base and having a aperture extending along at least part of its length; and a securing mechanism comprising a rod and a handle, wherein the rod extends through the central aperture into the hole; and the handle may be manipulated to fix the adjustment mechanism.

In a further embodiment, wherein when the embodiment comprises a front lip, the front lip forms an angle less than 90 degrees relative to the base.

In an exemplary embodiment of an adjustable stand, the adjustable stand comprises a base wherein the base comprises a front lip, a rear portion, and a holding site therebetween and a hole, the hole positioned behind the rear portion; an adjustment mechanism comprising a slider movably positioned on the base and having a aperture centrally positioned and extending along at least part of the slider length, wherein the aperture is aligned with the hole; and a securing mechanism comprising a rod and a handle at a first end of the rod, wherein the rod extends through the aperture and a second end of the rod is inside the hole; and the handle may be manipulated to fix the adjustment mechanism to the base.

The present disclosure includes disclosure of an adjustable stand for holding an object, comprising a base comprising a front lip having an inside face and a holding site for an object adjacent the inside face, and an adjustment mechanism configured to be positioned relative to the base, the adjustment mechanism capable of residing at multiple positions upon the base, each position of the multiple positions configured to hold the object at a different angle relative to the base.

The present disclosure includes disclosure of an adjustable stand for holding an object, wherein in at least one of the multiple positions of the adjustment mechanism, at least a portion of the adjustment mechanism extends into the holding site.

The present disclosure includes disclosure of an adjustable stand for holding an object, wherein the inside face forms a 90° angle relative to the base.

The present disclosure includes disclosure of an adjustable stand for holding an object, wherein the inside face comprises a bevel, the bevel forming an angle less than 90° degrees relative to the base.

The present disclosure includes disclosure of an adjustable stand for holding an object, wherein the base further comprises a rear portion, a hole defined within the rear portion, and wherein the adjustment mechanism comprises a slider having an elongated aperture defined therethrough, at least part of the elongated aperture aligned vertically with the hole.

The present disclosure includes disclosure of an adjustable stand for holding an object, further comprising a securing mechanism comprising a handle and a rod extending therefrom, wherein at least a portion of the rod is configured to extend through the aperture and into the hole.

The present disclosure includes disclosure of an adjustable stand for holding an object, wherein the rear portion has a notch defined therein, and wherein the slider is configured to slidingly engage the base within the notch.

The present disclosure includes disclosure of an adjustable stand for holding an object, wherein the inside face comprises a grip portion.

The present disclosure includes disclosure of an adjustable stand for holding an object, comprising a base, comprising a front lip having an inside face and a rear portion, wherein a holding site is defined between the front lip and the rear portion, wherein a notch is defined within the rear portion, and wherein a hole is defined within the notch, an adjustment mechanism comprising a slider configured to be movably positioned relative to the base within the notch, the adjustment mechanism defining an elongated aperture therethrough, wherein at least part of the elongated aperture aligns vertically with the hole, and a securing mechanism comprising a handle and a rod extending therefrom, wherein at least a portion of the rod is configured to extend through the aperture and into the hole, and whereby manipulation of the handle can secure the adjustment mechanism at a desired location relative to the base.

The present disclosure includes disclosure of an adjustable stand for holding an object, wherein the slider is configured to be positioned in at least two positions, wherein the securing mechanism is configured to be positioned at a first position and a second position; wherein when the securing mechanism is in the first position the slider can move toward the holding site and away from the holding site, and when the securing mechanism is in the second position the slider is secured to the base and unable to move relative to the base.

The present disclosure includes disclosure of an adjustable stand for holding an object, wherein the inside face comprises a grip portion.

The present disclosure includes disclosure of an adjustable stand for holding an object, wherein the inside face forms an angle of 90° or less relative to the base.

The present disclosure includes disclosure of an adjustable stand for holding an object, comprising a base an adjustment mechanism configured to be positioned relative to the base, the adjustment mechanism capable of residing at multiple positions upon the base, each position of the multiple positions configured to hold an object at a different angle relative to the base, and a securing mechanism configured to be positioned at a first position and at a second position, wherein when the securing mechanism is in the first position, the adjustment mechanism is movable relative to the base, and wherein when the securing mechanism is in the second position, the adjustment mechanism is not movable relative to the base

The present disclosure includes disclosure of an adjustable stand for holding an object, wherein the adjustment mechanism is a slider disposed on the base, the slider defining an elongated aperture therethrough that is aligned with a hole defined within the base.

The present disclosure includes disclosure of an adjustable stand for holding an object, wherein the base comprises a front lip having an

inside face, a rear portion, and a holding site therebetween, and wherein the slider is disposed upon the rear portion.

The present disclosure includes disclosure of an adjustable stand for holding an object, wherein the inside face forms an angle of 90° or less relative to the base.

The present disclosure includes disclosure of an adjustable stand for holding an object, wherein the inside face comprises a grip portion.

The present disclosure includes disclosure of an adjustable stand for holding an object, wherein the slider may be moved towards the front lip such the slider extends into the holding site.

The present disclosure includes disclosure of an adjustable stand for holding an object, wherein movement of the slider towards the front lip causes an angle of an object positioned within the holding site closer to 90° relative to the base.

The present disclosure includes disclosure of an adjustable stand for holding an object, wherein the securing mechanism comprises a handle and a rod extending therefrom, wherein at least a portion of the rod is configured to extend through the aperture and into the hole, wherein the hole is threaded to match the rod, and wherein the handle is rotatable to adjust a position of the adjustment mechanism relative to the base.

### BRIEF DESCRIPTION OF THE DRAWINGS

The disclosed embodiments and other features, advantages, and disclosures contained herein, and the matter of attaining them, will become apparent and the present disclosure will be better understood by reference to the following description of various exemplary embodiments of the present disclosure taken in conjunction with the accompanying drawings, wherein:

FIG. 1 shows a component view of an adjustable stand, according to an exemplary embodiment of the present disclosure;

FIG. 2 shows an angled top down view of a adjustable stand, according to an exemplary embodiment of the present disclosure;

FIG. 3 shows a side perspective view of an adjustable stand in use, according to an exemplary embodiment of the present disclosure;

FIG. 4 shows a side perspective view of an adjustable stand in use, according to another exemplary embodiment of the present disclosure;

FIG. 5 shows top, bottom, front, back, left side, and right side views of an exemplary base of an exemplary adjustable stand, according to an exemplary embodiment of the present disclosure;

FIG. 6 shows top, bottom, front, back, left side, and right side views of an exemplary slider (an exemplary adjustable mechanism) of an exemplary adjustable stand, according to an exemplary embodiment of the present disclosure;

FIG. 7 shows top, bottom, front, back, left side, and right side views of an exemplary securing mechanism of an exemplary adjustable stand, according to an exemplary embodiment of the present disclosure;

FIG. 8 shows top, bottom, front, back, left side, and right side views of an exemplary adjustable stand in a first combined configuration, including components shown in FIGS. 5, 6, and 7, according to an exemplary embodiment of the present disclosure;

FIG. 9 shows top, bottom, front, back, left side, and right side views of an exemplary adjustable stand in a second combined configuration, including components shown in FIGS. 5, 6, and 7, according to an exemplary embodiment of the present disclosure;

FIG. 10 shows top, bottom, front, back, left side, and right side views of an exemplary base of an exemplary adjustable stand whereby the base has a bevel in the front lip at an inside face/surface, according to an exemplary embodiment of the present disclosure;

FIG. 11 shows top, bottom, front, back, left side, and right side views of an exemplary adjustable stand in a first combined configuration, including components shown in FIGS. 7, 10, and 12, according to an exemplary embodiment of the present disclosure;

FIG. 12 shows top, bottom, front, back, left side, and right side views of an exemplary slider (an exemplary adjustable mechanism) of an exemplary adjustable stand, whereby the slider is relatively shorter than the slider shown in FIG. 6, according to an exemplary embodiment of the present disclosure;

FIG. 13 shows top, bottom, front, back, left side, and right side views of an exemplary base of an exemplary adjustable stand, with dashed lines indicating various grooves, openings, and nuts, according to an exemplary embodiment of the present disclosure;

FIG. 14 shows top, bottom, front, back, left side, and right side views of an exemplary securing mechanism of an exemplary adjustable stand, with dashed lines indicating portions of the threaded rod positioned within the securing mechanism, according to an exemplary embodiment of the present disclosure;

FIG. 15 shows top, bottom, front, back, left side, and right side views of an exemplary base of an exemplary adjustable stand, with dashed lines indicating environmental portions of the base that could have a different configuration than that shown in FIG. 5, such as with or without rounded corners or edges, and overall outside perimeter shape(s) of an exemplary adjustable stand, according to an exemplary embodiment of the present disclosure;

FIG. 16 shows top, bottom, front, back, left side, and right side views of an exemplary slider (an exemplary adjustable mechanism) of an exemplary adjustable stand, with dashed lines indicating environmental portions of the slider that could have a different configuration than that shown in FIG. 6, such as with or without rounded corners or edges, and overall outside perimeter shape(s) of an exemplary slider, according to an exemplary embodiment of the present disclosure;

FIG. 17 shows top, bottom, front, back, left side, and right side views of an exemplary securing mechanism of an exemplary adjustable stand, with dashed lines indicating environmental portions of the securing mechanism that could have a different configuration than that shown in FIG. 6, such as with or without rounded corners or edges, and overall outside perimeter shape(s) of an exemplary adjustable stand, according to an exemplary embodiment of the present disclosure;

FIG. 18 shows a perspective view of an exemplary adjustable mechanism, according to an exemplary embodiment of the present disclosure;

FIG. 19 shows top, bottom, front, back, left side, and right side views of an exemplary slider (an exemplary adjustable mechanism) of an exemplary adjustable stand, according to an exemplary embodiment of the present disclosure;

FIG. 20 shows top, bottom, front, back, left side, and right side views of an exemplary slider (an exemplary adjustable mechanism) of an exemplary adjustable stand, according to an exemplary embodiment of the present disclosure; and

FIG. 21 shows top, bottom, front, back, left side, and right side views of an exemplary slider (an exemplary adjustable mechanism) of an exemplary adjustable stand, according to an exemplary embodiment of the present disclosure.

An overview of the features, functions and/or configurations of the components depicted in the various figures will now be presented. It should be appreciated that not all of the features of the components of the figures are necessarily described. Some of these non-discussed features, such as various couplers, etc., as well as discussed features are inherent from the figures themselves. Other non-discussed features may be inherent in component geometry and/or configuration.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

For example, the embodiments below may refer specifically to holding or accepting an electronic device 102. However, it is within the scope of this disclosure to hold any suitable object 102 within the embodiments described. Furthermore, it is envisioned that the embodiments below may be operable without some of the features described, and that the embodiments are exemplary and non-limiting. Similarly, where a first embodiment is described without an element present in another embodiment, it is not implied that the first embodiment is exclusive of that element. Rather it is envisioned that elements described in one embodiment may be present in another embodiment even though not explicitly listed.

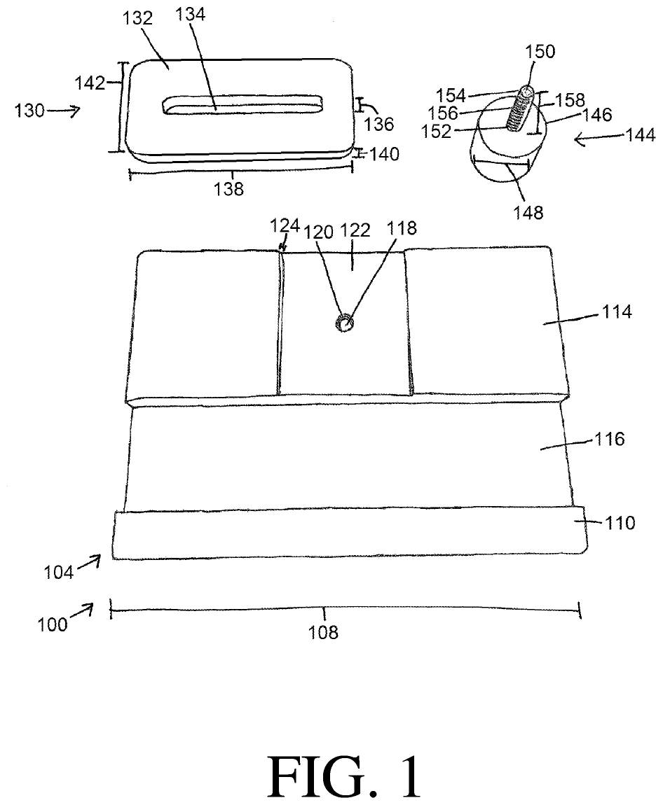

An exemplary device for an adjustable stand 100 comprised of a base 104, an adjustment mechanism 130 and a securing mechanism 144 is described. An exemplary embodiment of the present disclosure is shown in FIG. 1.

As shown in FIG. 1, the base 104 has flat bottom surface and a top surface having a front lip 110 and a holding site 116. As pictured in FIG. 1, the front lip 110 is a raised section of the base 104 and provides a border for the holding site 116. In FIG. 1, the front lip 110 is positioned at the front edge of the base 104. However, the front lip 110 may be located to the rear of the front edge as desired. An object 102, such as an electronic device 102 (smartphone, tablet, etc.), can be can be placed into the holding site 116 and will be prevented from sliding forward out of the holding site 116 by the raised front lip 110.

Embodiments of the device 100 may also comprise a rear portion 114. As shown FIG. 1, the rear portion 114 is raised similar to the front lip 110 and is located to the rear of the front lip 110. The holding site 116 is located between the front lip 110 and the rear portion 114. As it is surrounded by the front lip 110 and the rear portion 114, the holding site 116 takes the form of a channel or a groove in this embodiment. In the embodiment of FIG. 1, the front lip 110, rear portion 114 and holding site 116 are shown to extend across the width of the base 104. However, it is envisioned in an alternate embodiment, one or more of the front lip 110, holding site 116 or rear portion 114 may extend only partially across the base 104.

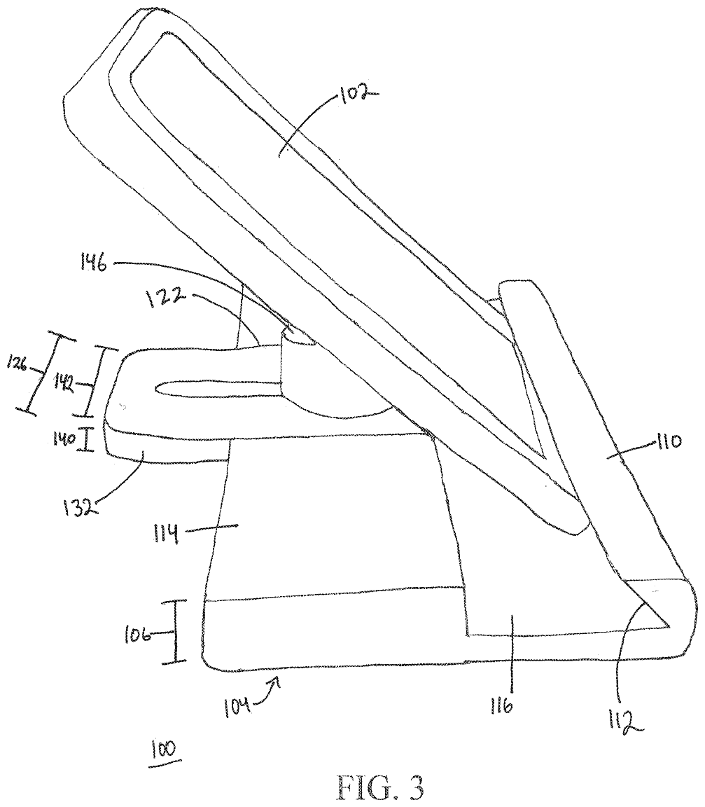

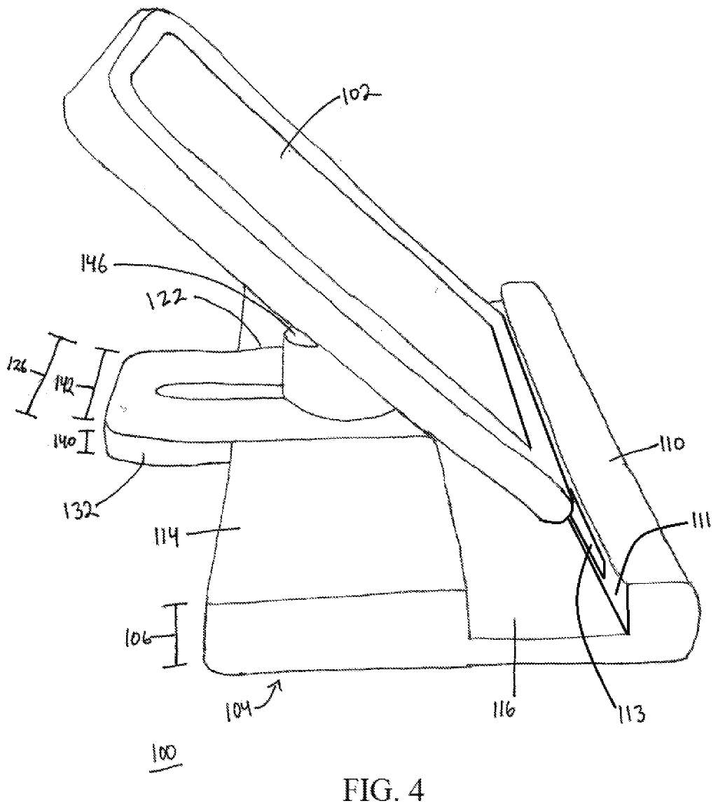

The inside face 111 of front lip 110 may have a bevel 112, such as shown in in FIG. 3, or the inside face 111 of front lip 110 may not have a bevel, instead being perpendicular with the base 104, such as shown in FIG. 4. Embodiments having a bevel 112, instead of being directly perpendicular to the base 104, the rear facing vertical wall of the front lip 110 may form an angle less than ninety degrees with the base 104. This bevel 112 can act to catch an object 102 deposited within the holding site 116 and allows the front lip 110 to securely hold the object 102.

Inside face 111 may also have a grip portion 113 defined therein or coupled thereto, whereby grip portion 113 provides additional grip (increases frictional engagement) between object 102 and device 100. Grip portion 113 may comprise rubber, plastic, sandpaper, another type of textured material, etc., so long as it provides additional grip (increases frictional engagement) between object 102 and device 100.

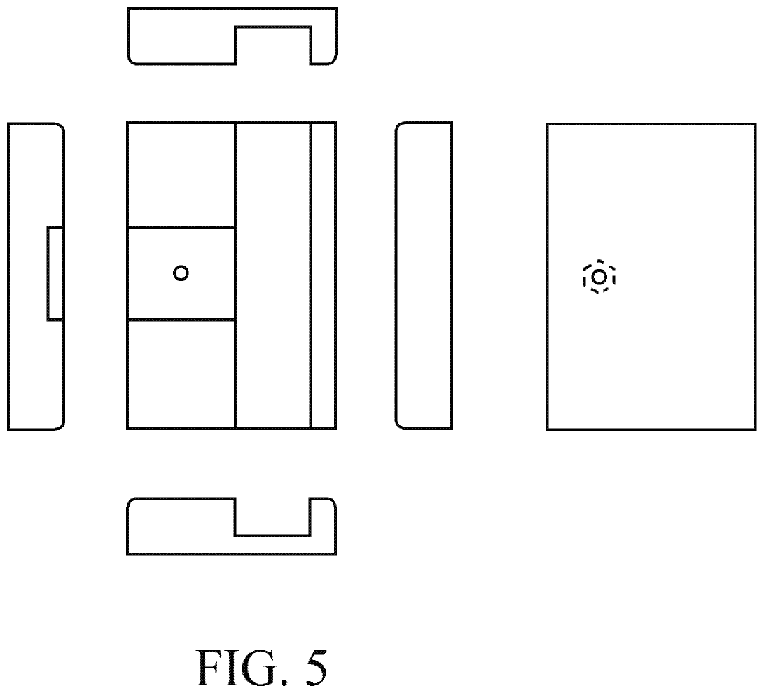

The base 104 also comprises (or defines) a receiving feature, such as a hole 118, for receiving the securing mechanism 144, as discussed further below. In the embodiment of FIG. 1, the hole 118 is located to the rear of the front lip 110 and the holding site 116. Furthermore, the receiving feature is configured to attach the securing mechanism 144 firmly to the base 104. The receiving feature may take any form that restricts movement of the securing mechanism 144 out of the receiving mechanism. In this embodiment, the hole 118 is threaded by way of a threaded nut or component 120, such as also shown in FIG. 5 in an environmental view.

The adjustable stand 100 also comprises an adjustment mechanism 130 comprising at least two positions. The adjustment mechanism 130 is configured to have at least two positions wherein each position can hold the object 102 at a different angle relative to the base 104.

In the embodiment of FIG. 1, the adjustment mechanism 130 comprises a slider 132 slidably disposed on the base 104 and disposed between the base 104 and the securing mechanism 144. The slider 132 is on the raised rear portion 114 of the base 104. The slider 132 has at least two positions relative to the base 104, wherein each position is more or less forward or backward than the others. The slider 132 also comprises an aperture 134 centrally located in the slider 132 and extending at least partially along the length 138 of the slider 132 and not extending to the edges of the slider 132. Other embodiments may include apertures 134 that extend to an edge of the slider 132. Other embodiments may also have teeth such as a ratcheting mechanism.

In FIG. 1, the slider 132 is limited to forward and backward movement by an alignment feature on the base 104. In this embodiment, the alignment feature comprises a notch 122 having a width 126 larger than the width 142 of the slider 132. In this embodiment the slider 132 is relatively thin and generally rectangular. The slider 132 is shaped to fit within the notch 122, and the notch 122 limits the movement of the slider 132 to a forward and backwards direction. The aperture 134 will also extend in a forwards and backwards direction in this embodiment and is aligned vertically with the hole 118. The aperture 134 works with the hole 118 and the securing mechanism 144 to limit the forward and backward movement of the slider 132. In an alternate embodiment the alignment feature comprises at least one rail.

The length 138 of the slider 132 is such that it may extend into the holding site 116 while being coupled with the base 104 and the securing mechanism 144. A combination of the length 138 of the slider 132 and the length of the aperture 134 will determine the maximum and minimum of the extent of the slider's potential protrusion into the holding site 116. The extent of actual slider protrusion into the holding site 116 determines the angle relative to the base 104 at which the object 102 in the holding site 116 will be held. In the embodiment of FIG. 1, the slider 132 and aperture 134 are each of a length such that the slider 132 may extend completely across the holding site 116.

The adjustable stand 100 further comprises a securing mechanism 144 configured to fix the slider 132 to the base 104. The securing mechanism 144 of an adjustable stand 100 shown in FIG. 1 comprises a handle 146 and a rod 150. The rod 150 extends through the aperture 134 of the slider 132 and further comprises a first end 152 of the rod 150 attached to the handle 146 and a second end 154 of the rod 150.

The second end 154 of the rod 150 comprises a diameter smaller than the diameter of the hole 118 in the base and the width 136 of the aperture 134. The second end 154 of the rod 150 may also be threaded 156 to match the hole 118. Therefore the second end 154 may pass through the aperture 134 and be rotatably inserted into the hole 118. The second end 154 of the rod 150 is removably attached to the hole 118.

The length of the rod, when measured from the point at which it extends from the handle to the second end 158 is longer than the height of the base 128. This allows the securing mechanism 144 to perform two functions when coupled to the base 104. The securing mechanism 144 in a first position performs the first function of preventing the adjustment mechanism 130, the slider 132, from uncoupling from the base 104 while still allowing the adjustment mechanism 130 to move forward and backward. The first position of the securing mechanism 144 is achieved by inserting the second end 154 of the rod 150 into the hole 118.

The securing mechanism 144 in a second position performs the second function of fixing the adjustment mechanism 130 to the base 104. In the second position of the securing mechanism 144, the adjustment mechanism 130 cannot move forward and backward and cannot uncouple from the base 104. When the securing mechanism 144 is in the second position, the adjustment mechanism 130 is fixed to the base 104. Fixing the adjustment mechanism 130 allows the stand user to select an angle at which the object 102 is held.

The second position of the securing mechanism 144 is achieved by inserting the second end 154 of the rod 150 further into the hole 118 than in the first position of the securing mechanism 114. In this position the securing mechanism 144 exerts a compressive force onto the slider 132 so that friction between the base 104 and the slider 132 and between the handle 146 and the slider 132 prevent the slider 132 from moving.

The dimensions of various elements are configured to enable to securing mechanism 144 in the second position to fix the slider 132. In this embodiment, the handle 146 is configured so that it cannot pass through the aperture 134. The diameter 148 of the handle 146 is larger than the width 136 of the aperture 134. Turning the handle 146 advances the rod 150 into the hole 118 along their matching threads 126, 156. As the handle 146 is attached to the rod 150, it also moves downward in the direction of the slider 132 and base 104 and presses the slider 132 into the base 104. The handle 146 is also pressed against the slider 132.

The handle 146, notch 122, and slider 132 may vary in dimension as long as the securing mechanism 144 is able to fix the adjustment mechanism 130. For example, it is envisioned that the securing mechanism 144 may still be operable when the diameter 148 of the handle 146 is larger than the width 126 of the notch 122, such as when the slider height 140 is greater than the height of the notch 124. Where the slider height 140 is smaller than the notch height 124, the handle 146 may have a diameter 148 smaller than the width 126 of the notch 122. Of course, further variations are acceptable, such as in an embodiment wherein the handle 146 has a diameter 148 smaller than the notch width 126 and the slider 132 has a height 140 greater than the notch height 124.

Additionally, where the slider height 140 may vary greatly from the notch height 124, the length of the rod 150 may also vary. The rod 150 must be of sufficient length to insert into the hole 118 when the slider 132 is placed between the handle 146 and the base 104.

FIG. 1 shows a component view of an adjustable stand, according to an exemplary embodiment of the present disclosure.

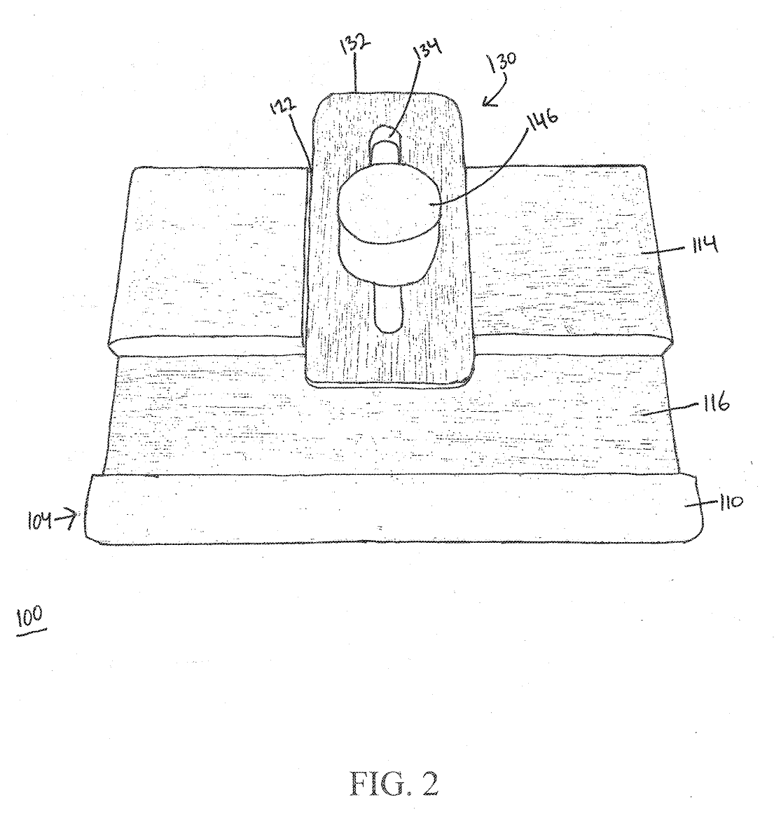

FIG. 2 shows an angled top down view of a adjustable stand, according to an exemplary embodiment of the present disclosure.

FIG. 3 shows a side perspective view of an adjustable stand in use, according to an exemplary embodiment of the present disclosure.

FIG. 4 shows a side perspective view of an adjustable stand in use, according to another exemplary embodiment of the present disclosure.

FIG. 5 shows top, bottom, front, back, left side, and right side views of an exemplary base of an exemplary adjustable stand, according to an exemplary embodiment of the present disclosure.

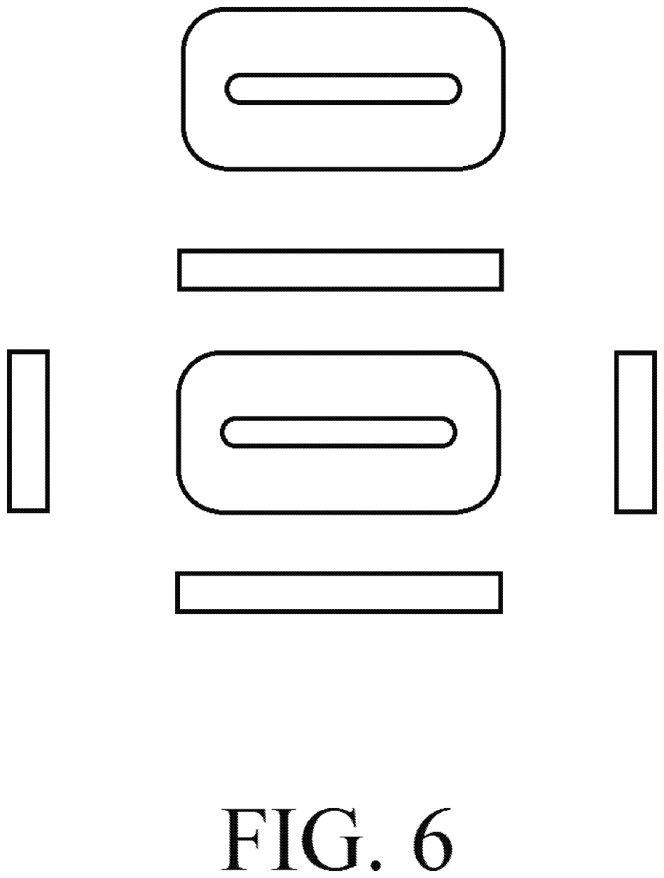

FIG. 6 shows top, bottom, front, back, left side, and right side views of an exemplary slider (an exemplary adjustable mechanism) of an exemplary adjustable stand, according to an exemplary embodiment of the present disclosure.

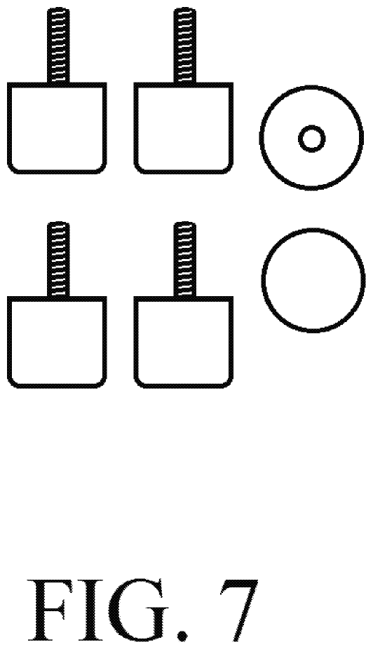

FIG. 7 shows top, bottom, front, back, left side, and right side views of an exemplary securing mechanism of an exemplary adjustable stand, according to an exemplary embodiment of the present disclosure.

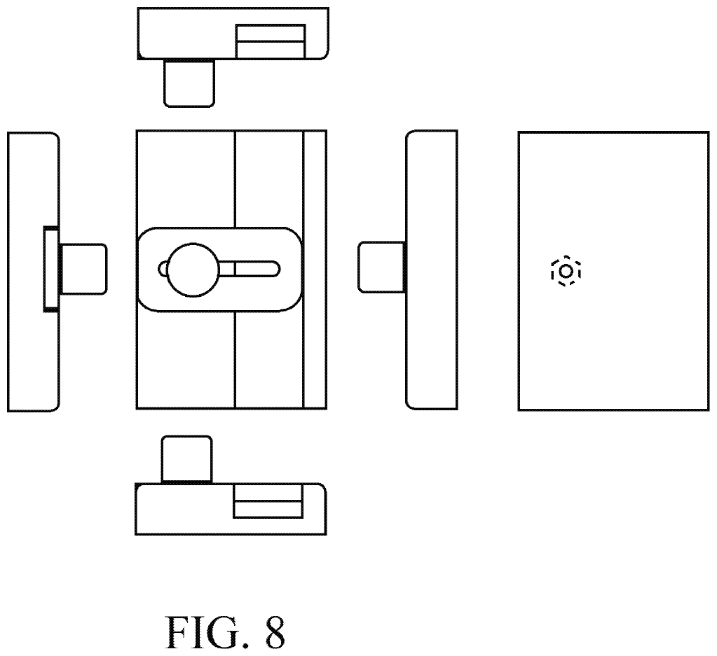

FIG. 8 shows top, bottom, front, back, left side, and right side views of an exemplary adjustable stand in a first combined configuration, including components shown in FIGS. 5, 6, and 7, according to an exemplary embodiment of the present disclosure.

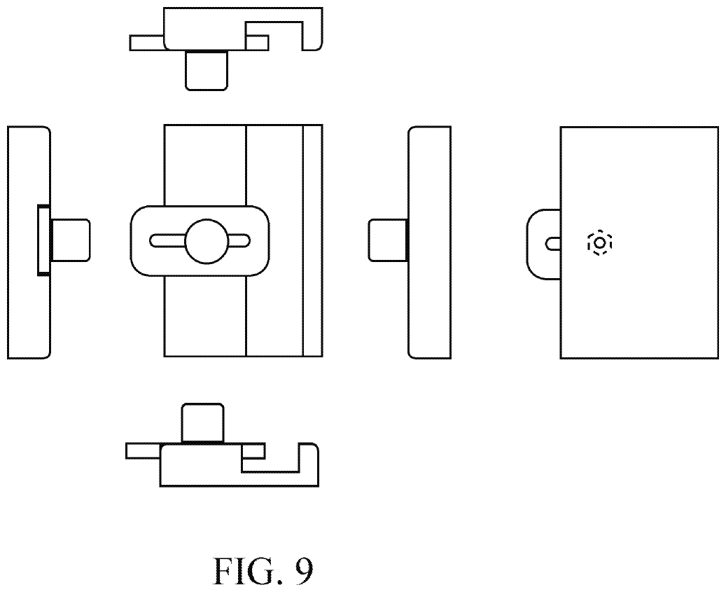

FIG. 9 shows top, bottom, front, back, left side, and right side views of an exemplary adjustable stand in a second combined configuration, including components shown in FIGS. 5, 6, and 7, according to an exemplary embodiment of the present disclosure.

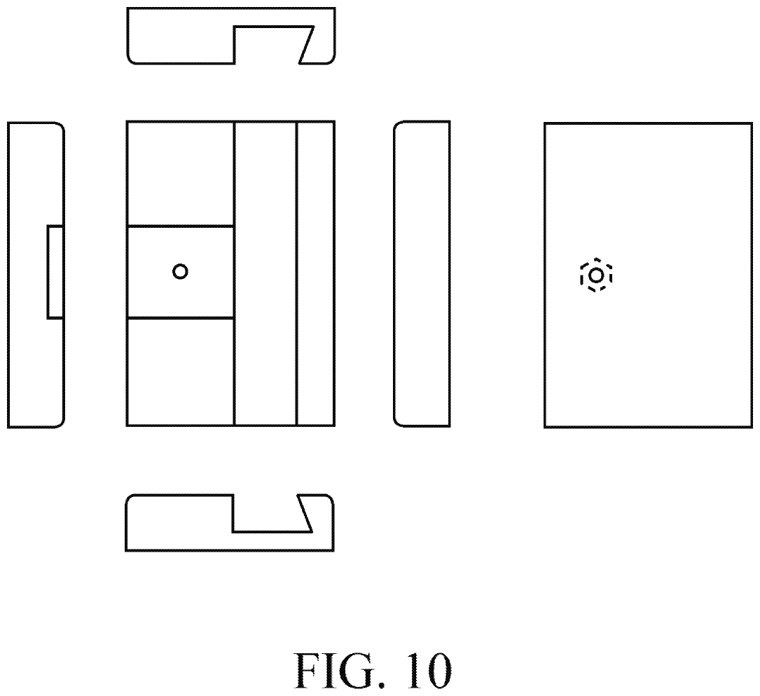

FIG. 10 shows top, bottom, front, back, left side, and right side views of an exemplary base of an exemplary adjustable stand whereby the base has a bevel in the front lip at an inside face/surface, according to an exemplary embodiment of the present disclosure.

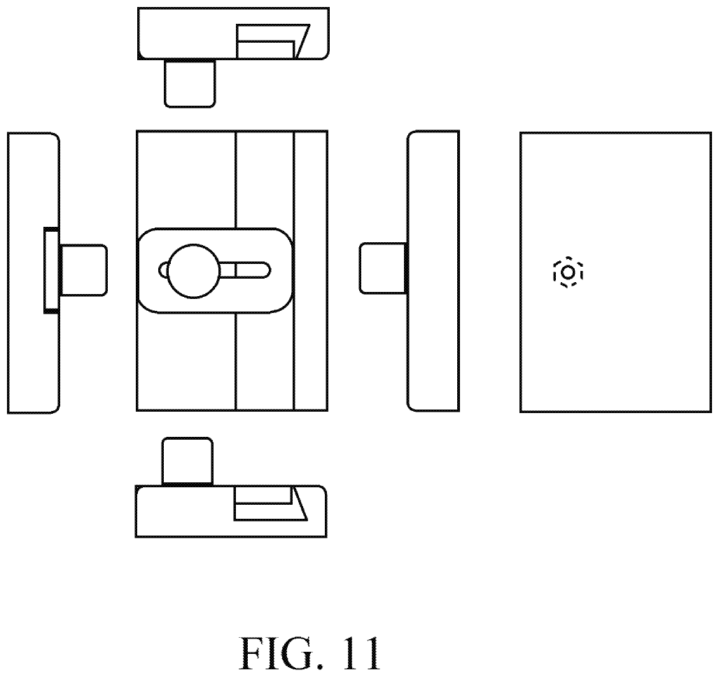

FIG. 11 shows top, bottom, front, back, left side, and right side views of an exemplary adjustable stand in a first combined configuration, including components shown in FIGS. 7, 10, and 12, according to an exemplary embodiment of the present disclosure.

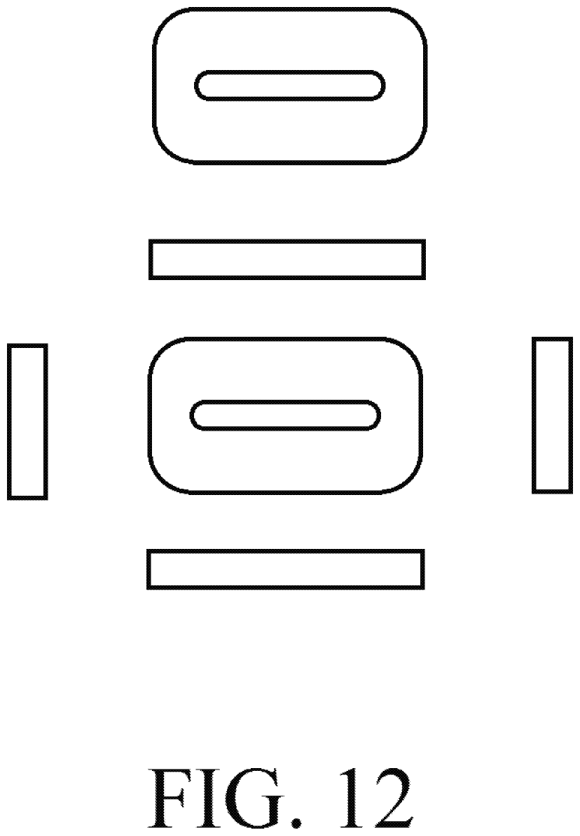

FIG. 12 shows top, bottom, front, back, left side, and right side views of an exemplary slider (an exemplary adjustable mechanism) of an exemplary adjustable stand, whereby the slider is relatively shorter than the slider shown in FIG. 6, according to an exemplary embodiment of the present disclosure.

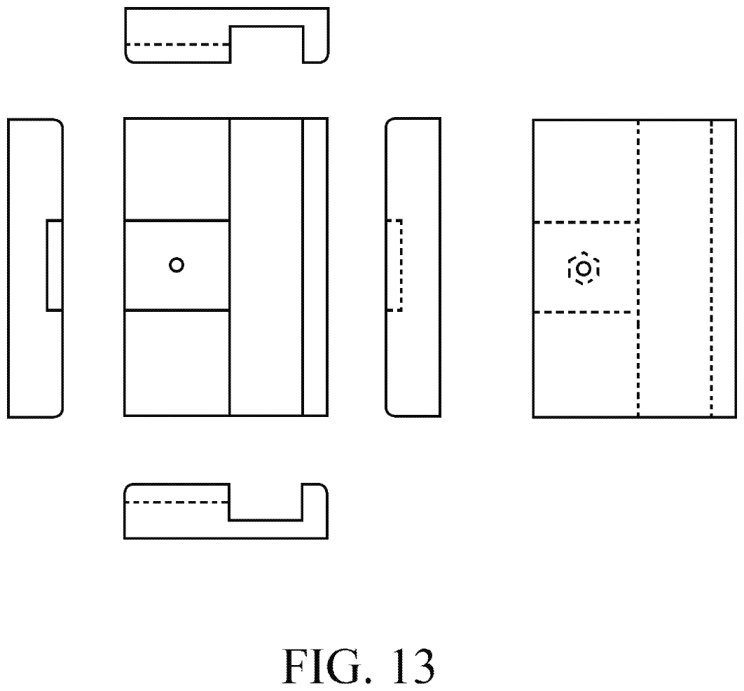

FIG. 13 shows top, bottom, front, back, left side, and right side views of an exemplary base of an exemplary adjustable stand, with dashed lines indicating various grooves, openings, and nuts, according to an exemplary embodiment of the present disclosure.

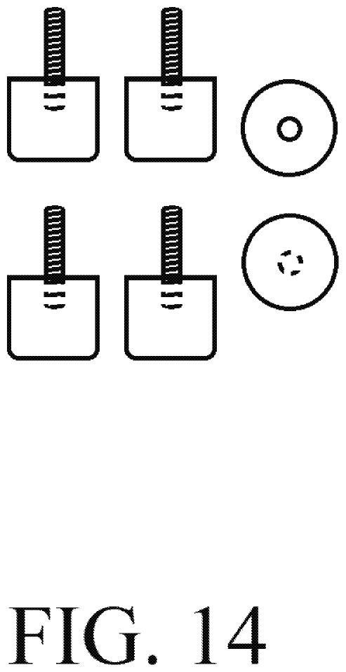

FIG. 14 shows top, bottom, front, back, left side, and right side views of an exemplary securing mechanism of an exemplary adjustable stand, with dashed lines indicating portions of the threaded rod positioned within the securing mechanism, according to an exemplary embodiment of the present disclosure.

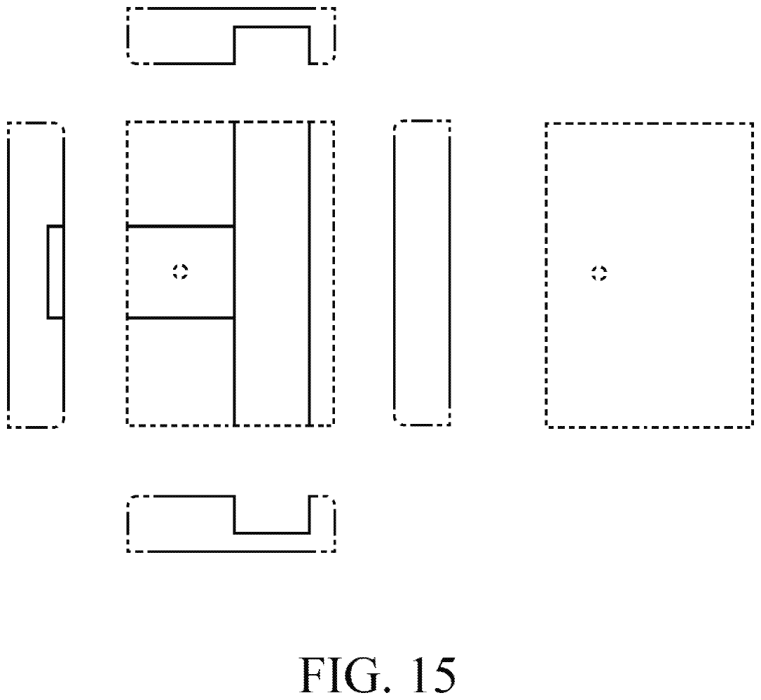

FIG. 15 shows top, bottom, front, back, left side, and right side views of an exemplary base of an exemplary adjustable stand, with dashed lines indicating environmental portions of the base that could have a different configuration than that shown in FIG. 5, such as with or without rounded corners or edges, and overall outside perimeter shape(s) of an exemplary adjustable stand, according to an exemplary embodiment of the present disclosure.

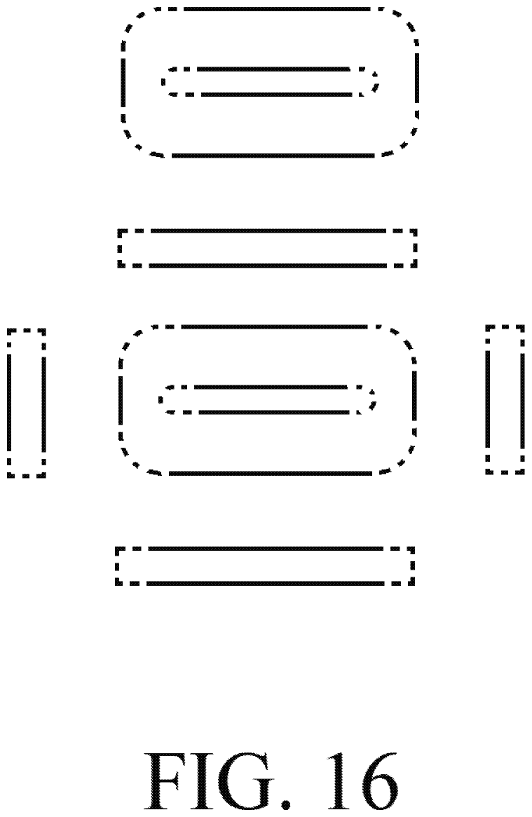

FIG. 16 shows top, bottom, front, back, left side, and right side views of an exemplary slider (an exemplary adjustable mechanism) of an exemplary adjustable stand, with dashed lines indicating environmental portions of the slider that could have a different configuration than that shown in FIG. 6, such as with or without rounded corners or edges, and overall outside perimeter shape(s) of an exemplary slider, according to an exemplary embodiment of the present disclosure.

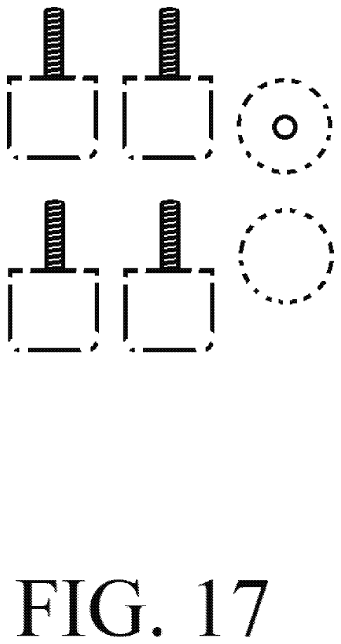

FIG. 17 shows top, bottom, front, back, left side, and right side views of an exemplary securing mechanism of an exemplary adjustable stand, with dashed lines indicating environmental portions of the securing mechanism that could have a different configuration than that shown in FIG. 6, such as with or without rounded corners or edges, and overall outside perimeter shape(s) of an exemplary adjustable stand, according to an exemplary embodiment of the present disclosure.

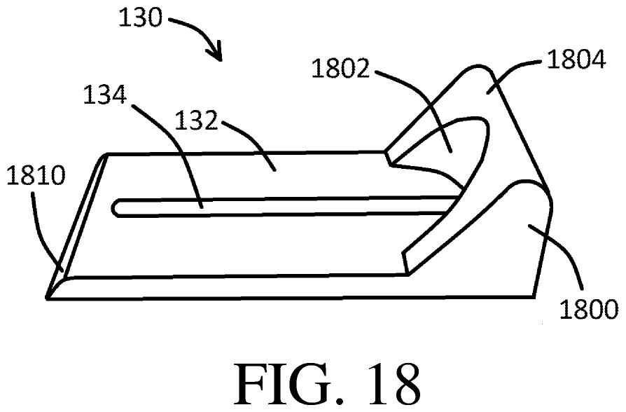

FIG. 18 shows an exemplary embodiment of an adjustment mechanism 130 of the present disclosure. As shown in FIG. 18, adjustment mechanism 130 comprises a slider 132 defining an elongated aperture 134 therethrough, extending at least partially along a length of the slider 132. As shown in FIG. 18, adjustment mechanism 130 may further comprise a raised grip portion 1800, said raised grip portion having an optional indentation 1804 defined therein, so to allow a user to be able to more readily maneuver adjustment mechanism 130 relative to base 110. Raised grip portion 1800 may also have a rounded upper portion 1802, as may be desired. Adjustment mechanism 130 may also have a curved end 1810, said curved end 1810 having a profile similar to an end profile of base 110 in various embodiments.

FIG. 18 shows a perspective view of an exemplary adjustable mechanism, according to an exemplary embodiment of the present disclosure.

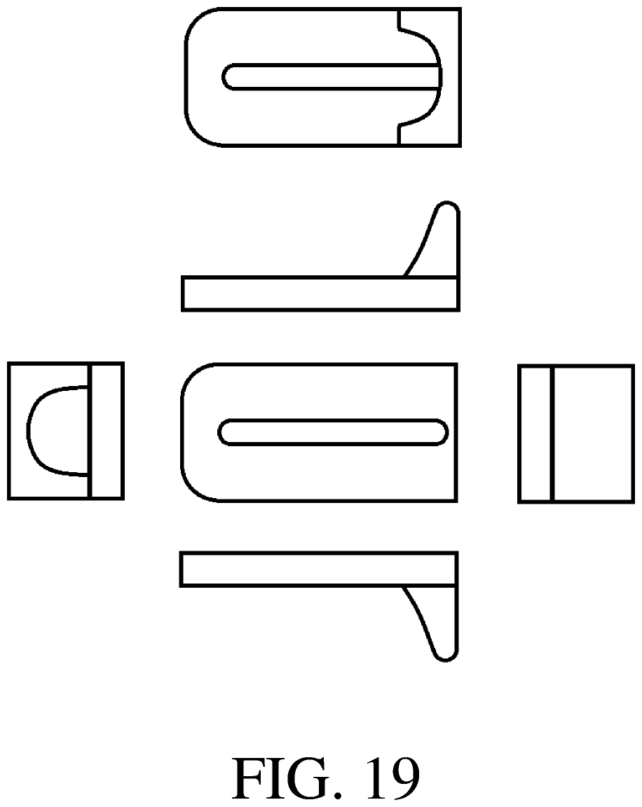

FIG. 19 shows top, bottom, front, back, left side, and right side views of an exemplary slider (an exemplary adjustable mechanism) of an exemplary adjustable stand, according to an exemplary embodiment of the present disclosure.

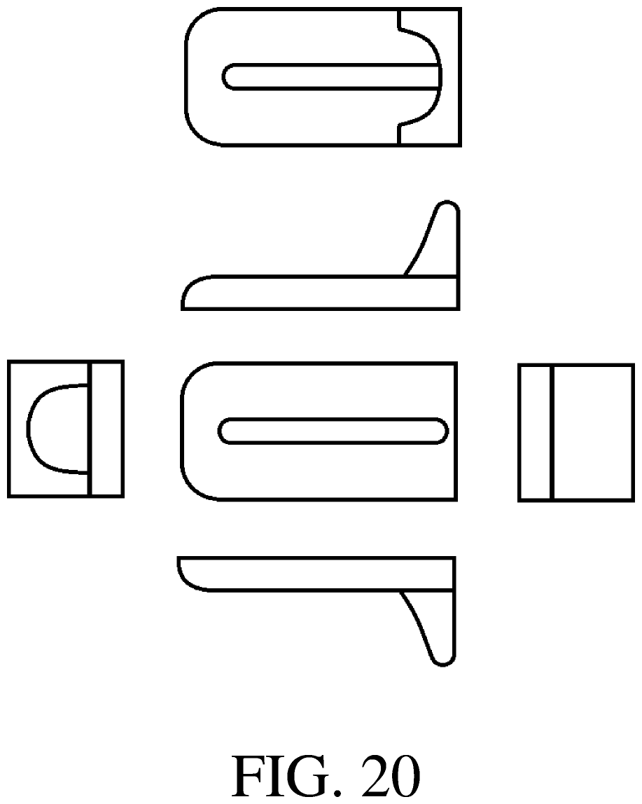

FIG. 20 shows top, bottom, front, back, left side, and right side views of an exemplary slider (an exemplary adjustable mechanism) of an exemplary adjustable stand, according to an exemplary embodiment of the present disclosure.

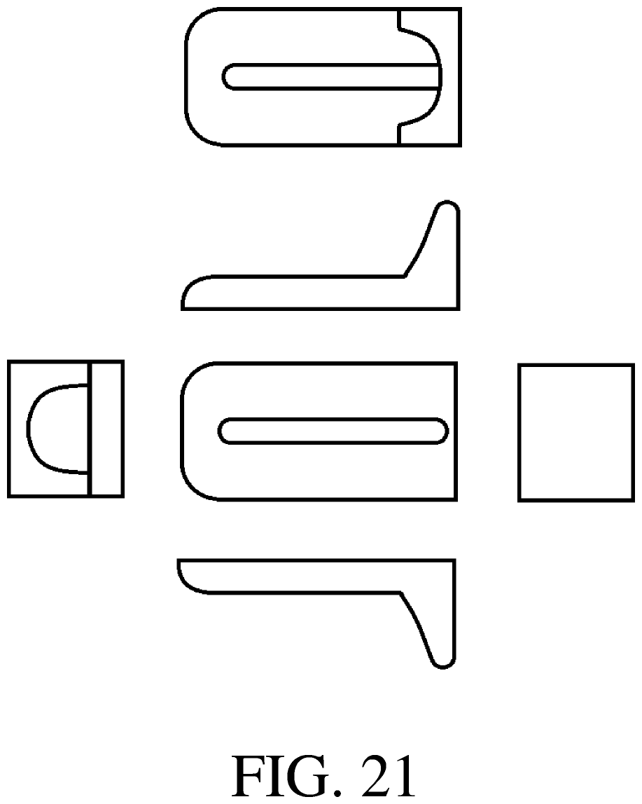

FIG. 21 shows top, bottom, front, back, left side, and right side views of an exemplary slider (an exemplary adjustable mechanism) of an exemplary adjustable stand, according to an exemplary embodiment of the present disclosure.

While various embodiments of devices for an adjustable stand have been described in considerable detail herein, the embodiments are merely offered as non-limiting examples of the disclosure described herein. It will therefore be understood that various changes and modifications may be made, and equivalents may be substituted for elements thereof, without departing from the scope of the present disclosure. The present disclosure is not intended to be exhaustive or limiting with respect to the content thereof.

Further, in describing representative embodiments, the present disclosure may have presented a method and/or a process as a particular sequence of steps. However, to the extent that the method or process does not rely on the particular order of steps set forth therein, the method or process should not be limited to the particular sequence of steps described, as other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. An adjustable stand for holding an object, comprising:
a base comprising:
a front lip having an inside face; and
a holding site for an object adjacent the inside face; and
an adjustment mechanism configured to be positioned relative to the base, the adjustment mechanism capable of residing at multiple positions upon the base, each position of the multiple positions configured to hold the object at a different angle relative to the base.

2. The adjustable stand of claim 1, wherein in at least one of the multiple positions of the adjustment mechanism, at least a portion of the adjustment mechanism extends into the holding site.

3. The adjustable stand of claim 1, wherein the inside face forms a 90° angle relative to the base.

4. The adjustable stand of claim 1, wherein the inside face comprises a bevel, the bevel forming an angle less than 90° degrees relative to the base.

5. The adjustable stand of claim 1, wherein the base further comprises:
a rear portion;
a hole defined within the rear portion; and
wherein the adjustment mechanism comprises a slider having an elongated aperture defined therethrough, at least part of the elongated aperture aligned vertically with the hole.

6. The adjustable stand of claim 5, further comprising:
a securing mechanism comprising a handle and a rod extending therefrom, wherein at least a portion of the rod is configured to extend through the aperture and into the hole.

7. The adjustable stand of claim 5, wherein the rear portion has a notch defined therein, and wherein the slider is configured to slidingly engage the base within the notch.

8. The adjustable stand of claim 1, wherein the inside face comprises a grip portion.

9. An adjustable stand for holding an object, comprising:
a base, comprising:
a front lip having an inside face; and
a rear portion;
wherein a holding site is defined between the front lip and the rear portion;
wherein a notch is defined within the rear portion; and
wherein a hole is defined within the notch;
an adjustment mechanism comprising a slider configured to be movably positioned relative to the base within the notch, the adjustment mechanism defining an elongated aperture therethrough, wherein at least part of the elongated aperture aligns vertically with the hole; and
a securing mechanism comprising a handle and a rod extending therefrom, wherein at least a portion of the rod is configured to extend through the aperture and into the hole, and whereby manipulation of the handle can secure the adjustment mechanism at a desired location relative to the base.

10. The adjustable stand of claim 9, wherein the slider is configured to be positioned in at least two positions, wherein the securing mechanism is configured to be positioned at a first position and a second position; wherein when the securing mechanism is in the first position the slider can move toward the holding site and away from the holding site, and when the securing mechanism is in the second position the slider is secured to the base and unable to move relative to the base.

11. The adjustable stand of claim 10, wherein the inside face comprises a grip portion.

12. The adjustable stand of claim 10, wherein the inside face forms an angle of 90° or less relative to the base.

13. An adjustable stand for holding an object comprising:
a base;
an adjustment mechanism configured to be positioned relative to the base, the adjustment mechanism capable of residing at multiple positions upon the base, each position of the multiple positions configured to hold an object at a different angle relative to the base; and
a securing mechanism configured to be positioned at a first position and at a second position;
wherein when the securing mechanism is in the first position, the adjustment mechanism is movable relative to the base; and
wherein when the securing mechanism is in the second position, the adjustment mechanism is not movable relative to the base

14. The adjustable stand of claim 13, wherein the adjustment mechanism is a slider disposed on the base, the slider defining an elongated aperture therethrough that is aligned with a hole defined within the base.

15. The adjustable stand of claim 14, wherein the base comprises a front lip having an inside face, a rear portion, and a holding site therebetween, and wherein the slider is disposed upon the rear portion.

16. The adjustable stand of claim 13, wherein the inside face forms an angle of 90° or less relative to the base.

17. The adjustable stand of claim 13, wherein the inside face comprises a grip portion.

18. The adjustable stand of claim 14, wherein the slider may be moved towards the front lip such the slider extends into the holding site.

19. The adjustable stand of claim 18, wherein movement of the slider towards the front lip causes an angle of an object positioned within the holding site closer to 90° relative to the base.

20. The adjustable stand of claim 19, wherein the securing mechanism comprises a handle and a rod extending therefrom, wherein at least a portion of the rod is configured to extend through the aperture and into the hole, wherein the hole is threaded to match the rod, and wherein the handle is rotatable to adjust a position of the adjustment mechanism relative to the base.
